(19) United States
(12) Patent Application Publication
(10) Pub. No.: US 2017/0012396 A1
(43) Pub. Date: Jan. 12, 2017

(54) Cable Assembly, Camera Module, And Camera Device For Vehicle Including Same

(71) Applicant: Tyco Electronics AMP Korea Co. Ltd, Gyungsangbuk-do (KR)

(72) Inventors: Gi Chan Kwon, Gyungsangbuk-do (KR); Chang Jae Choi, Gyungsangbuk-do (KR)

(73) Assignee: Tyco Electronics AMP Korea Co. Ltd, Gyungsangbuk-do (KR)

(21) Appl. No.: 15/271,393

(22) Filed: Sep. 21, 2016

Related U.S. Application Data
(63) Continuation of application No. PCT/KR2015/001207, filed on Feb. 5, 2015.

(30) Foreign Application Priority Data
Mar. 21, 2014 (KR) 10-2014-0033392
Apr. 23, 2014 (KR) 10-2014-0048796
Jul. 2, 2014 (KR) 10-2014-0082334

(51) Int. Cl. H01R 24/50; H04N 5/225; H04N 7/10; H01R 12/71; H01R 13/24

(52) U.S. Cl. CPC H01R 24/50; H01R 12/714; H01R 13/2428; H04N 7/10; H04N 5/2251; H01R 2201/26

(57) ABSTRACT

A camera device for a vehicle, the camera device including a camera module, a cable assembly, and a plurality of spring terminals. The camera module has a printed circuit board. The cable assembly includes a coaxial cable and a plurality of signal cables that connect the camera module and the vehicle. The spring terminals are formed of a conductive material and are at one side of the camera module or at one side of the cable assembly to resiliently connect the signal cables spring cable and the printed circuit board.

### CROSS-REFERENCE TO RELATED APPLICATIONS

This application is a continuation of PCT International Application No. PCT/KR2015/001207 filed Feb. 5, 2015, which claims priority under 35 U.S.C. §119 to Korean Patent No. 10-2014-0033392 filed Mar. 21, 2014, Korean Patent No. 10-2014-0048796 filed Apr. 23, 2014 and Korean Patent No. 10-2014-0082334 filed Jul. 2, 2014.

### FIELD OF THE INVENTION

The present invention relates to a camera device used for a vehicle and, more particularly, to a cable assembly including a coaxial cable, a camera module, and a camera device for a vehicle including the cable assembly and the camera module.

### BACKGROUND

A rear-view camera is provided in a vehicle to enable a driver sitting in a driver seat to verify a rear view of a vehicle through a display screen when moving the vehicle in reverse. In general, the rear-view camera is installed inside an emblem at a rear side of the vehicle.

The rear-view camera may include a plurality of cables including, for example, a cable connected to the vehicle and configured to receive operating power and a cable connected to a monitor device provided in the vehicle. In general, to receive power for operating the rear-view camera, a method of directly receiving a direct current (DC) 12 voltage (V) from a tail lamp of the vehicle without a voltage drop and a method of dropping a voltage to DC 5V through a voltage regulator may be used. However, when DC 12V, power of the vehicle, is applied directly to the rear-view camera as operating power, a large amount of heat may be generated when dropping the voltage to approximately DC 5V in a circuit included in a camera device. In addition, a quality of an image to be captured by a camera may deteriorate due to such a heat generation, and video noise may occur due to an oscillation.

### SUMMARY

A camera device for a vehicle, constructed in accordance with the present invention, comprises a camera module, a cable assembly, and a plurality of spring terminals. The camera module has a printed circuit board. The cable assembly is adapted to connect the camera module to the vehicle and has a coaxial cable and a plurality of signal cables. The plurality of spring terminals is at least at one of one side of the camera module and at one side of the cable assembly. The spring terminals, formed of a conductive material, elastically connect the signal cables and the printed circuit board.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is an exploded perspective view of a camera device for a vehicle including a cable assembly and a camera module according to an example embodiment;

FIG. 2 is a perspective view of the cable assembly of FIG. 1;

FIG. 3 is an exploded perspective view of the cable assembly of FIG. 2;

FIG. 4 is an exploded perspective view of a main portion of the cable assembly of FIG. 3;

FIG. 5 is a perspective view of a spring terminal of the cable assembly of FIG. 2;

FIG. 6 is an exploded perspective view of an example of a modified cable assembly according to an example embodiment;

FIG. 7 is an exploded perspective view of a camera device for a vehicle including a cable assembly and a camera module according to another example embodiment;

FIG. 8 is a bottom perspective view of the cable assembly of FIG. 7;

FIG. 9 is an exploded perspective view of the cable assembly of FIG. 7;

FIG. 10 is an exploded perspective view of a camera device for a vehicle including a cable assembly and a camera module according to still another example embodiment;

FIG. 11 is a perspective view of the cable assembly of FIG. 10;

FIG. 12 is an exploded perspective view of the cable assembly of FIG. 11;

FIG. 13 is an exploded perspective view of a holder of the camera module of FIG. 10;

FIG. 14 is an exploded perspective view of an example of a modified holder according to an example embodiment;

FIG. 15 is an exploded perspective view of a camera device for a vehicle including a cable assembly and a camera module according to yet another example embodiment; and

FIG. 16 is an exploded perspective view of the cable assembly of FIG. 14.

### DETAILED DESCRIPTION OF THE EMBODIMENTS

Hereinafter, example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The terminology used herein is for the purpose of describing particular embodiments only and is not intended to be limiting. Terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the disclosure that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the disclosure that one component is “directly connected” or “directly joined” to another component, a third component may not be present therebetween. Likewise, expressions, for example, “between” and “immediately between” and “adjacent to” and “immediately adjacent to” may also be construed as described in the foregoing.

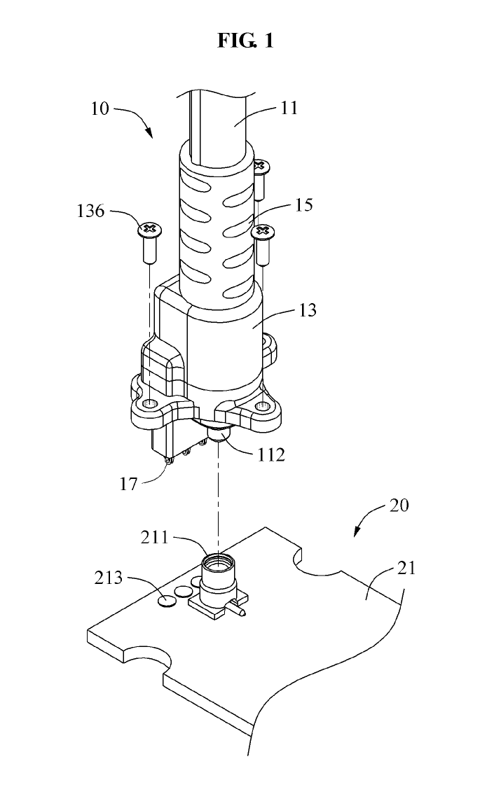

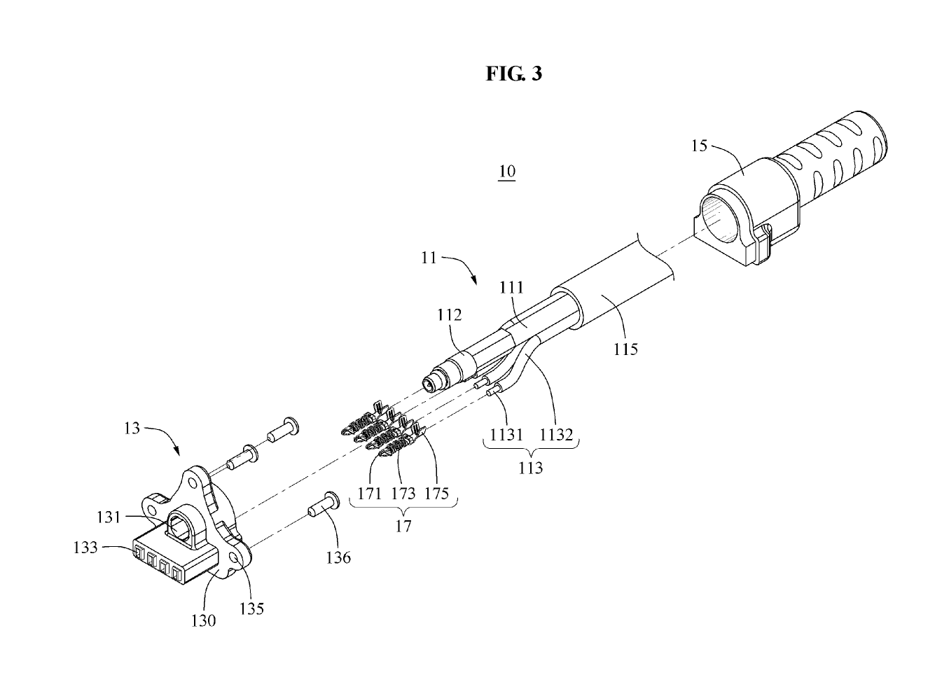

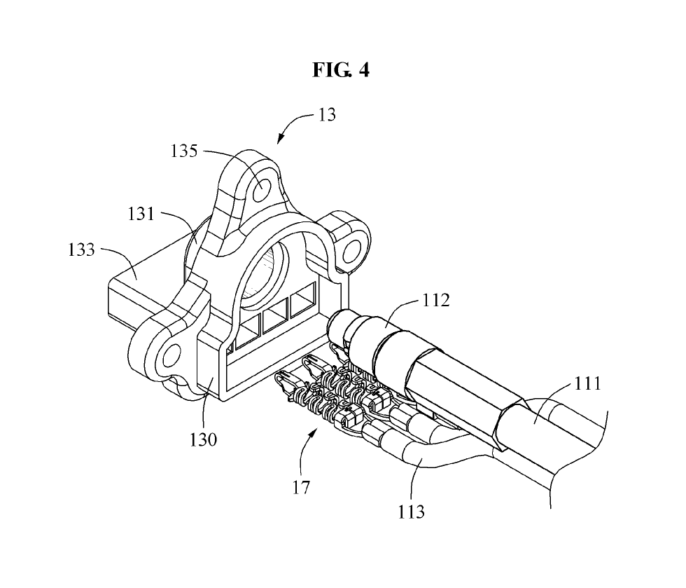

Referring to FIGS. 1 through 5, the camera device for a vehicle includes a camera module 20 and a cable assembly 10 configured to connect the camera module 20 to the vehicle.

The camera module 20 includes a printed circuit board (PCB) 21, a micro-miniature coaxial (MMCX) connector 211 to be connected to a coaxial cable 111, and a plurality of connection pads 213 to be connected to a plurality of signal cables 113 of the cable assembly 10. A detailed illustration and description of the camera module 20 will be omitted herein because a detailed configuration of the camera module 20 is understood from a well-known configuration.

The cable assembly 10 includes the coaxial cable 111 and the signal cables 113, which are, in combination, referred to as a cable portion 11. Since the cable portion 11 is modularized by a single connector housing 13 provided at an end of the cable portion 10, the coaxial cable 111 and the signal cables 113 may not be separately combined, and thus may be simultaneously connected to or separated from the camera module 20.

In detail, the cable assembly 10 includes the cable portion 11 and the connector housing 13. The cable portion 11 includes the coaxial cable 111 to transmit an image signal, and the signal cables 113 to supply power and transmit a signal. The coaxial cable 111 is aligned in a same direction as a direction of the signal cables 113 and accommodated in a sheath 115 to form a single cable. However, the present disclosure is not limited to the illustrative example described herein, and thus the sheath 115 may be omitted.

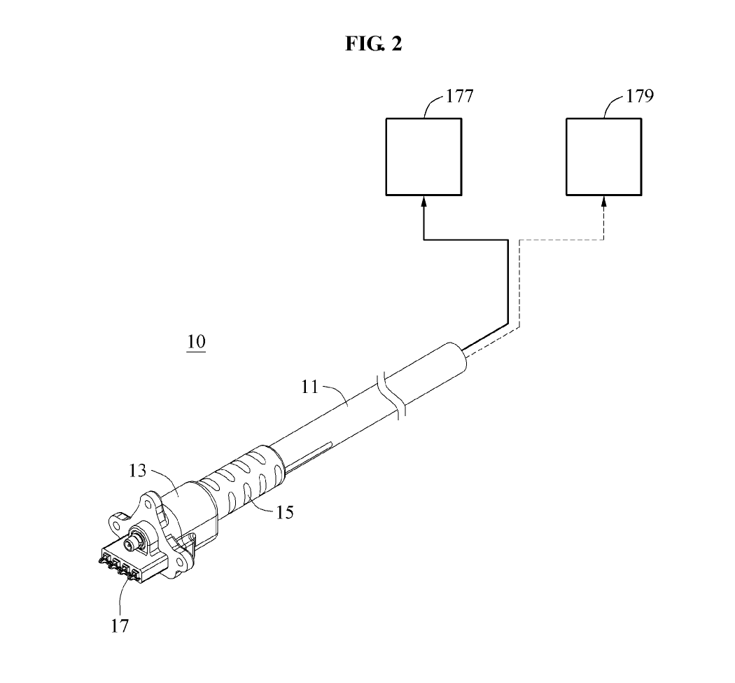

Reference numerals 177 and 179 in FIG. 2 indicate in-vehicle devices to be connected to the coaxial cable 111 and the signal cables 113. An overmolded portion 15 is formed to connect the cable portion 11 and the connector housing 13. For example, the overmolded portion 15 may be formed in a portion of the sheath 115 to connect the sheath 115 and the connector housing 13. The overmolded portion 15 is formed of a same material as a material of the sheath 115 and/or the connector housing 13. However, the present disclosure is not limited to the illustrative example described herein and thus the overmolded potion 15 may connect the cable portion 11 and the connector housing 13 in an absence of the sheath 115. In addition, a shape and a size of the overmolded portion 15 are not limited to the illustrative example described herein, and thus various modifications may be made to the shape and the size.

The connector housing 13 is provided at an end of the cable portion 11 and includes a body 130, a joint 135, and a fastener 136. To connect the cable portion 11 to the PCB 21, the connector housing 13 also includes a first cable joint 131 to which a first micro-miniature coaxial (MMCX) connector 112 is to be connected and a second cable joint 133 to which an end of the signal cables 113 is to be connected.

Here, the coaxial cable 111 is connected to the first MMCX connector 112. That is, MMCX connectors, for example, the first MMCX connector 112 and a second MMCX connector 211, are provided, respectively, in an end of the coaxial cable 111 and the PCB 21 to be connected. For example, the first cable joint 131 may be formed as a hole into which the first MMCX connector 112 is to be inserted to penetrate therethrough. The signal cables 113 are connected to the camera module 20 through the spring terminal 17 and the second cable joint 133 is formed as a hole into which the spring terminal 17 is inserted to penetrate therethrough. In addition, the second cable joint 133 protrudes by a preset length to accommodate the spring terminal 17. However, the present disclosure is not limited to the illustrative example described herein and thus various modifications may be made to a shape of the connector housing 13.

The spring terminal 17 electrically connects the signal cables 113 and the PCB 21, and applies elasticity to maintain stable connection between the signal cables 113 and the PCB 21. The spring terminal 17 is formed of a conductive material. In addition, the spring terminal 17 is provided in an integral form to facilitate assembling and enable an improved productivity.

In detail, the spring terminal 17 includes, at one end thereof, a contact point portion 171 to be electrically connected to the PCB 21. For example, the contact point portion 171 may include a curved surface formed by an end of a wire or a plate forming a spring 173 being bent at a preset curvature. Due to the curved surface of the contact point portion 171, a size of an area to be in contact with the connection pads 213 of the PCB 21 may increase, and thus the signal cables 113 and the PCB 21 may be stably connected. In addition, since an end of the contact point portion 171 is bent, the contact point portion 171 provides elasticity when the spring terminal 17 is connected to the connection pads 213.

The spring terminal 17 includes, at another end thereof, a connection end 175 to be connected to the signal cables 113. For example, the connection end 175 may be provided in a form of a clip or a flange, and may be connected and fixed when the connection end 175 is deformed while being compressed against a circumference of a core wire 1131 of the signal cables 113.

The spring 173 is provided in an integral form between the contact point portion 171 and the connection end 175 and provides elasticity to the spring terminal 17. The spring 173 is formed by one plate or wire being split and bent a plurality of times. For example, the spring 173 may be formed along a lengthwise direction of the spring terminal 17 to have a preset length and formed by a wire having a preset diameter or a plate having a preset thickness being repetitively split or bent a plurality of times to be in a W shape. In addition, the spring 173 may be bent to allow a shape of a cross section obtained by being cut vertically to the lengthwise direction of the spring terminal 17 to be any one shape between an open shape (e.g., a C shape and a flattened U shape) and a closed shape (e.g., a circular shape and a polygonal shape). That is, the spring 173 may be formed to be in a hollow cylindrical shape or a polygonal column shape, as a whole. The spring terminal 17 may have elasticity when a W-shaped portion is deformed, or may have strength greater than or equal to a predetermined magnitude due to the cylindrical or polygonal column shape. Thus, the spring terminal 17 may be formed to be light in weight and small in size and to have elasticity greater than or equal to a predetermined magnitude. However, the shape of the spring 173 is not limited to the illustrative example described herein and thus various modifications that provide elasticity may be made to the shape.

As described in the foregoing, the spring terminal 17 includes the contact point portion 171, the spring 173, and the connection end 175. However, a formation of the spring terminal 17 is not limited to the illustrative example described herein and thus the spring 173 and the contact point portion 171 may be formed as a single portion. That is, since the contact point portion 171 is bent at a preset curvature and size to have elasticity, the spring 173 may be omitted and only the contact point portion 171 may provide elasticity that is sufficient to elastically connect the spring terminal 17 to the PCB 21.

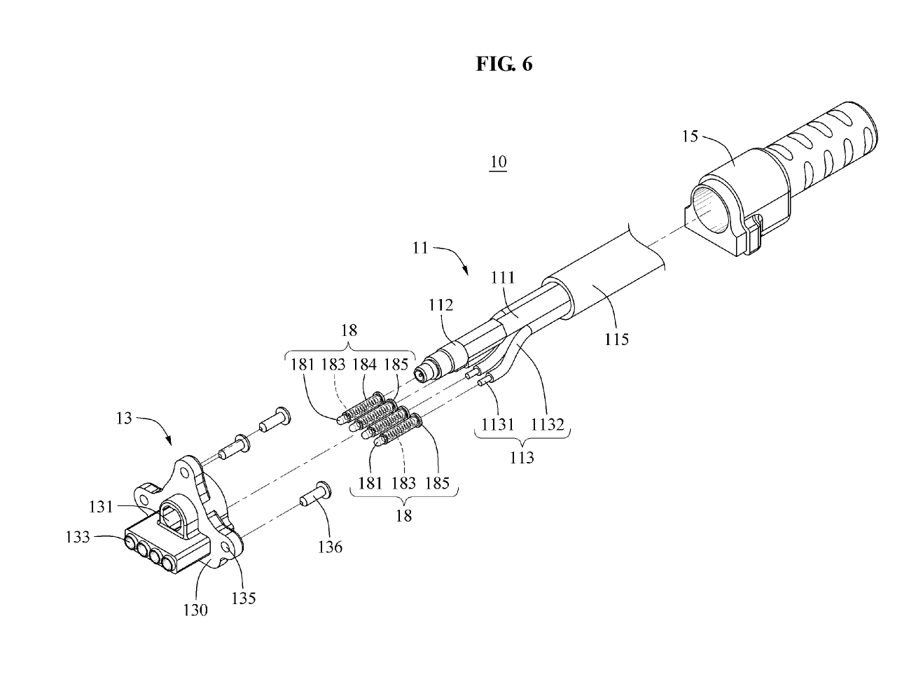

Although the integrally-formed spring terminal 17 is described in the foregoing, a pogo pin 18 may be used in place of the spring terminal 17 as illustrated in FIG. 6.

The cable assembly 10 to be described hereinafter is identical to the example described above, except for the pogo pin 18. Thus, only the pogo pin 18 will be described hereinafter and the same elements or components of the cable assembly 10 will be described using the same names and reference numerals and repeated descriptions will be omitted.

Referring to FIG. 6, the pogo pin 18 includes, at one end thereof, a contact point portion 181 to be electrically connected to the PCB 21 and includes, at another end thereof, a connection end 185 to be connected to the signal cables 113. In addition, the pogo pin 18 is formed to allow at least a portion of the contact point portion 181 to protrude out of the connector housing 13. The contact point portion 181 of the pogo pin 18 is inserted into a body 184 by a preset length and a spring 183 is included in the body 184. Thus, when the pogo pin 18 is in contact with the PCB 21, the contact point portion 181 may move forward and backward in the body 184. Although the pogo pin 18 is provided in place of the spring terminal 17, a structure of the cable assembly 10 may not be substantially changed compared to the example described above.

The cable assembly 10 may be assembled in the following sequence. A portion of the sheath 115 may be removed from the cable portion 11 to expose a portion of the coaxial cable 111 and the signal cables 113. Here, the sheath 115 may be omitted and the coaxial cable 111 and a bundle of the signal cables 113 may be used.

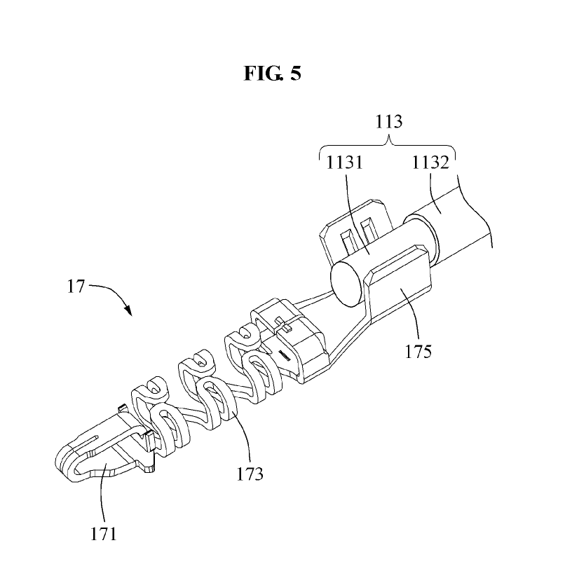

Subsequently, a sheath of the coaxial cable 111 may be removed from a portion of an end of the coaxial cable 111 to connect the first MMCX connector 112. A sheath 1132 of the signal cables 113 may be removed from a portion of an end of the signal cables 113 to expose the core wire 1131 and the connection end 175 of the spring terminal 17 may be fastened to the core wire 1131 to be compressed thereon as illustrated in FIG. 5.

The first MMCX connector 112 may be inserted into the first cable joint 131 and the spring terminal 17 may be inserted into the second cable joint 133. The spring terminal 17 is provided in an integral form and thus the spring terminal 17 and the signal cables 113 may be readily connected simply by compressing the connection end 175 against an end of the signal cables 113 without an additional process, for example, soldering.

The overmolded portion 15 may be formed to fix the connector housing 13 and the assembling may be completed. Here, since the coaxial cable 111 and the signal cables 113 of the cable assembly 10 are integrally modularized by the connector housing 13. Thus, the assembling may be readily performed without a need to connect cables to mount the cable assembly 10 onto the PCB 21.

When using the pogo pin 18 in lieu of the spring terminal 17 as illustrated in FIG. 6, the sheath 1132 may be removed from the signal cables 113 to expose the core wire 1131, and the core wire 1131 may be soldered to the connection end 185 of the pogo pin 18 and then inserted into the second cable joint 133 to allow the contact point portion 181 of the pogo pin 18 to be exposed outwards. An assembling process using the pogo pin 18 may be understood from well-known technology and thus detailed illustration and description will be omitted. When using the pogo pin 18, other elements or components of the cable assembly 10 may be the same as the elements or components described above.

Referring to the description provided in the foregoing, the first cable joint 131 and the second cable joint 133 of the connector housing 13 are aligned with each other along a direction of the cable portion 11. However, the present disclosure is not limited to the illustrative example described herein. Thus, the cable assembly 10 may be connected by a connector housing 14 being bent at 90 degrees (°).

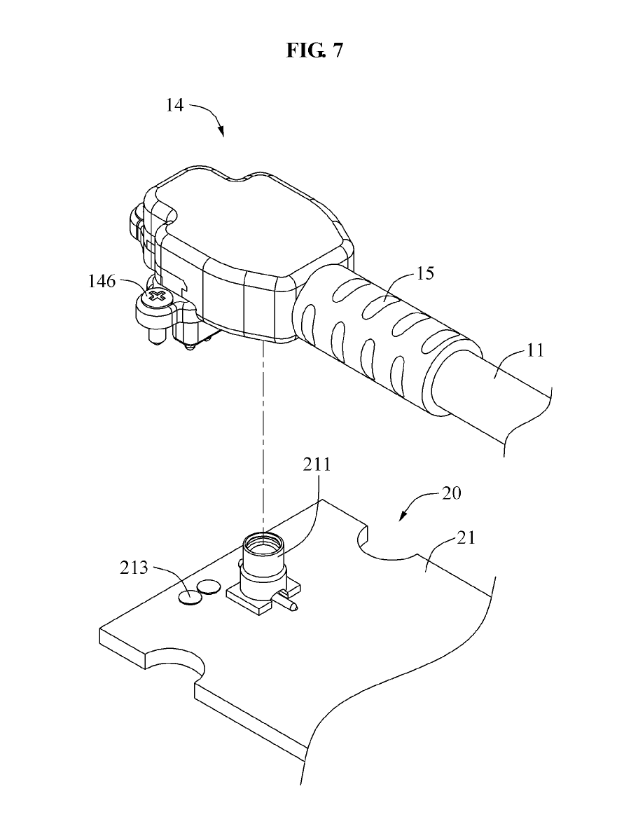

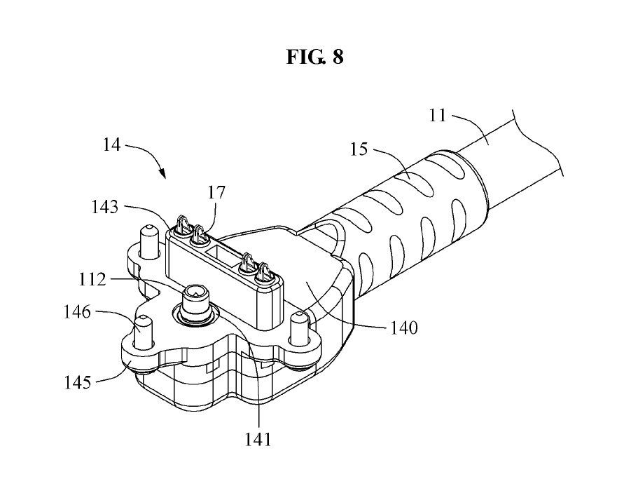

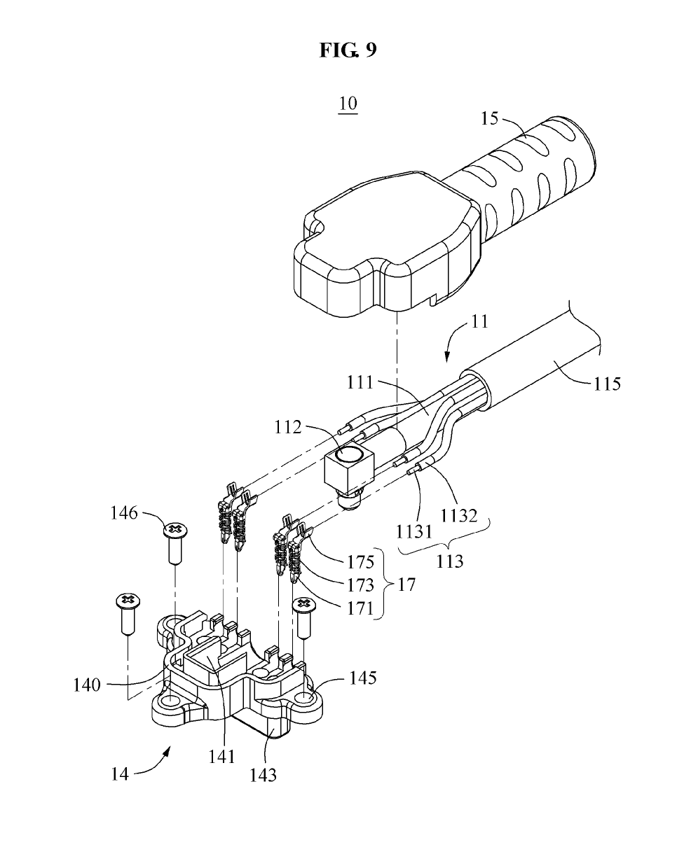

Hereinafter, the cable assembly 10 in a form bent at 90° will be described with reference to FIGS. 7 through 9. FIG. 7 is an exploded perspective view of a camera device for a vehicle including the cable assembly 10 and the camera module 20 according to another example embodiment. FIG. 8 is a bottom perspective view of the cable assembly 10 of FIG. 7. FIG. 9 is an exploded perspective view of the cable assembly 10 of FIG. 7. The cable assembly 10 to be described hereinafter is substantially the same as the cable assembly 10 described above, except for the connector housing 14. Thus, the same elements or components of the cable assembly 10 will be described using the same names and reference numerals and repeated descriptions will be omitted.

Referring to FIGS. 7 through 9, the cable assembly 10 includes the cable portion 11 including the coaxial cable 111, the signal cables 113, the sheath 115, the connector housing 14 provided at an end of the cable portion 11 to connect the cable portion 11 to the PCB 21, and the overmolded portion 15 to connect the cable portion 11 and the connector housing 14. Here, the sheath 115 may be omitted from the cable assembly 10.

The connector housing 14 is formed to connect the cable portion 11 to the PCB 21 by being bent at 90° against the PCB 21. That is, a first cable joint 141 and a second cable joint 143 of the connector housing 14 are bent at 90° against a direction of the cable portion 11.

Here, in the connector housing 14, the coaxial cable 111 and the signal cables 113 are aligned along an extended direction and the first MMCX connector 112 and the spring terminal 17 are provided in a bent form. For example, the first MMCX connector 112 may be provided in a form having an angle of 90° and the spring terminal 17 may be provided in a form bent at 90°. Thus, by changing shapes of the first MMCX connector 112 and the spring terminal 17 as illustrated, the coaxial cable 111 and the signal cables 113 may not need to be bent and thus connection may be readily performed and assembly may be improved. Here, the connector housing 14 includes a body 140 and a joint 145 to which a fastener 146 is to be fastened. However, the present disclosure is not limited to the illustrative example described herein and thus various modifications may be made to a shape of the connector housing 14.

A pogo pin may also be used in place of the spring terminal 17. Detailed illustration and description of using the pogo pin are omitted.

Referring to the description provided above, the spring terminal 17 may be provided in the cable assembly 10. However, the spring terminal 17 may also be provided in the PCB 21 of the camera module 20.

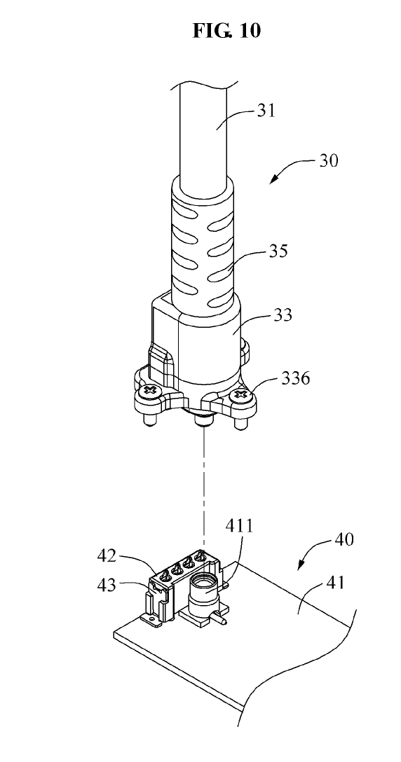

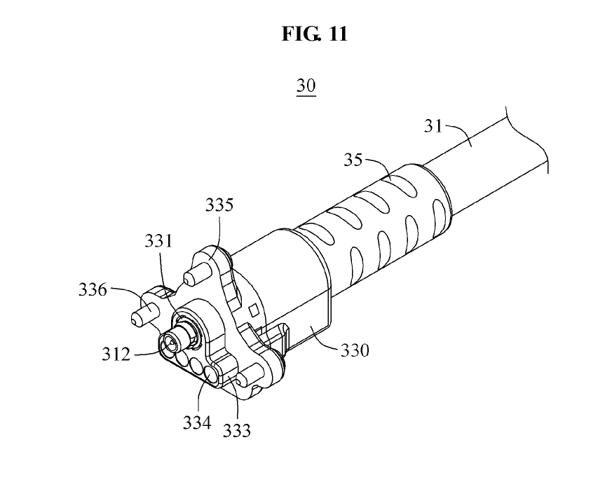

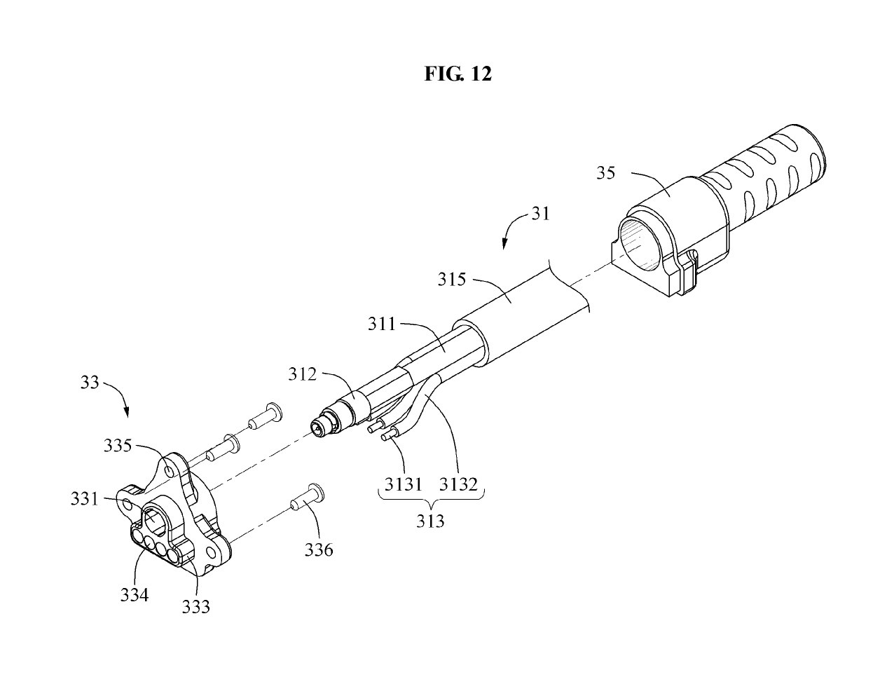

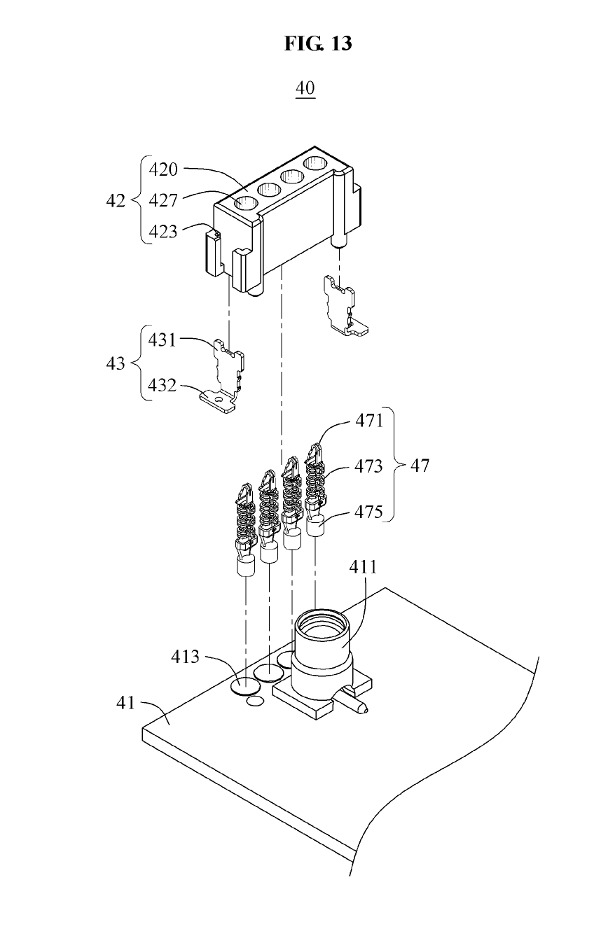

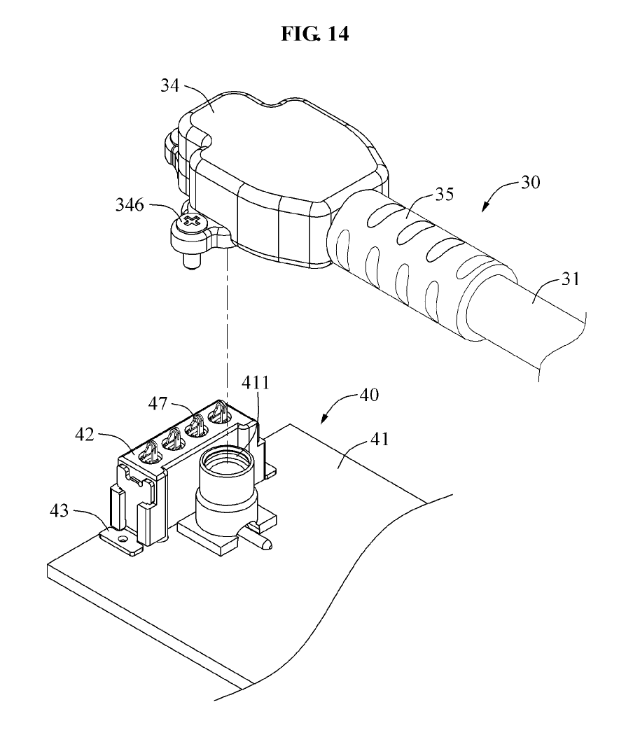

Hereinafter, an example of a modified camera device for a vehicle in which a spring terminal 47 is provided in a PCB 41 will be described with reference to FIGS. 10 through 16. FIG. 10 is an exploded perspective view of the camera device including a cable assembly 30 and a camera module 40 according to still another example embodiment. FIG. 11 is a perspective view of the cable assembly 30 of FIG. 10. FIG. 12 is an exploded perspective view of the cable assembly 30 of FIG. 11. FIG. 13 is an exploded perspective view of a holder 42 of the camera module 40 of FIG. 10. FIG. 14 is an exploded perspective view of an example of a modified holder 42 according to an example embodiment.

The connector assembly 30 to be described with reference to FIGS. 10 through 12 is substantially the same as the connector assembly 10 described with reference to FIGS. 1 through 6, except for an absence of a spring terminal. Thus, the same elements or components will be described using the same names and reference numerals and repeated descriptions will be omitted here.

Referring to FIGS. 10 through 12, the cable assembly 30 includes a cable portion 31, a connector housing 33, and an overmolded portion 35. The cable portion 31 includes a coaxial cable 311, a first MMCX connector 312, a plurality of signal cables 313, and a sheath 315. The overmolded portion 35 connects the connector housing 33 and the cable portion 31.

The connector housing 33 is provided at an end of the cable portion 31 and includes a first cable joint 331 to which the first MMCX connector 312 is to be connected to connect the cable portion 31 to the PCB 41 and a second cable joint 333 to which an end of the signal cables 313 is to be connected. Here, the signal cables 313 are connected to a signal pin 334 of the connector housing 33 without a spring terminal. For example, in the connector housing 33, the signal cables 313 may be soldered to the signal pin 334. The coaxial cable 311 and the signal cables 313 of the cable assembly 30 are integrally modularized by the connector housing 33 and thus assembling may be readily performed to mount the cable assembly 30 onto the PCB 41.

Referring to FIGS. 13 and 14, the spring terminal 47 is provided to elastically connect the signal cables 313 and a connection pad 413 of the PCB 41 and is provided on the PCB 41. The PCB 41 includes the holder 42 to accommodate the spring terminal 47.

The holder 42 includes a housing 420 in which the spring terminal 47 is to be accommodated and the housing 420 includes a spring terminal accommodator 427 provided to expose at least a portion of a contact point portion 471 of the spring terminal 47. Here, a plurality of spring terminals may be provided as the spring terminal 47. For example, for easier connection to the cable assembly 30, the spring terminal 47 and a second MMCX connector 411 are provided vertically to the PCB 41 and the holder 42 is formed to allow the spring terminal 47 to be vertically provided.

A fixing member 43 is also provided to fix the holder 42 to the PCB 41. For example, a portion of the fixing member 43, for example, a fixer 431, may be connected to a side face of the holder 42 and an end of the fixing member 43, for example, a soldered portion 432, may be provided in or fixed to the PCB 41 through soldering. However, the present disclosure is not limited to the illustrative example described herein and various modifications may be made to a shape of the holder 42. Here, a fixing member joint 423 to which the fixing member 43 is to be connected is also provided.

The spring terminal 47 includes, at another end thereof, a connection end 475 to be connected to and sit on the connection pad 413 of the PCB 41 and includes, at one end thereof, the contact point portion 471 to be connected to the cable assembly 30 and also includes a spring 473 providing elasticity.

The spring 473 is provided in an integral form between the contact point portion 471 and the connection end 475 to provide elasticity to the spring terminal 47. The spring 473 is formed by one plate or wire being split or bent a plurality of times. For example, the spring 473 is formed at a preset length along a lengthwise direction of the spring terminal 47. The spring 473 may be formed by a wire having a preset diameter or a plate having a preset thickness being bent a plurality of times to be a W shape. Also, the spring 473 is bent to allow a shape of a cross-section obtained by being cut vertically to the lengthwise direction of the spring terminal 47 to be any one shape between an open shape (e.g., a C shape and a flattened U shape) and a closed shape (e.g., a circular shape and a polygonal shape). That is, the spring 473 is formed to be in a hollow cylindrical shape or a polygonal column shape, as a whole. The spring terminal 47 may have elasticity when a W-shaped portion is deformed, or have strength greater than or equal to a predetermined magnitude due to the cylindrical or polygonal column shape. Thus, the spring terminal 47 may be formed to be light in weight and small in size to have elasticity greater than or equal to a predetermined magnitude. However, the present disclosure is not limited to the illustrative example described herein and thus various modifications that provide elasticity may be made to the shape of the spring 473.

The contact point portion 471 includes a curved surface formed by an end thereof being bent at a preset curvature. The contact point portion 471 is formed by an end of a wire or plate extended from the spring 473 being bent. In such a case, the contact point portion 471 may provide elasticity along with the spring 473 to connect the spring terminal 47 to the connection pad 413 of the PCB 41. In addition, due to the curved surface of the contact point portion 471, a size of an area to be in contact with the cable assembly 30 may be secured for stable connection and damage that may be done to an area in which the connection is to be made may be prevented.

Although the spring terminal 47 includes the contact point portion 471, the spring 473, and the connection end 475, the present disclosure is not limited to the illustrative example described herein. Thus, the spring 473 and the contact point portion 471 may be provided in an integral form. That is, the contact point portion 471 may be bent such that the contact point portion 471 has elasticity and thus the spring 473 may be omitted and only the contact point portion 471 may provide elasticity sufficient to elastically connect the spring terminal 47 to the cable assembly 30.

The connection end 475 is formed to be mounted onto the connection pad 413. For example, the connection end 475 may be provided in a cylindrical or polygonal form of a preset size. However, the present disclosure is not limited to the illustrative example described herein and thus various modifications may be made to a shape of the spring terminal 47.

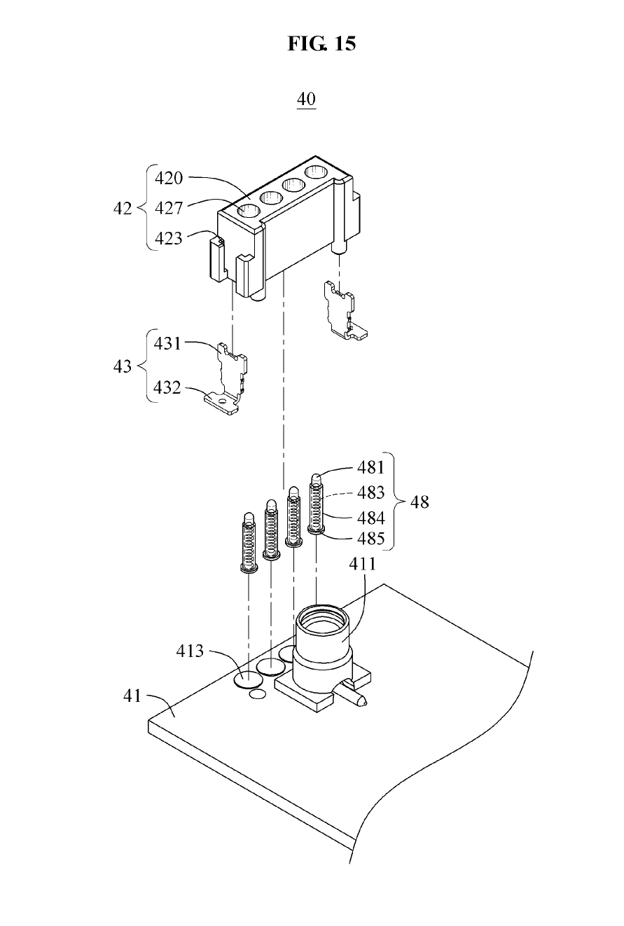

As illustrated in FIG. 15, a pogo pin 48 may be used for the holder 42 in place of the spring terminal 47. A structure of the holder 42 to be described hereinafter is substantially the same as the example described above, except for the use of the pogo pin 48 in place of the spring terminal 47. Thus, only the pogo pin 48 will be described hereinafter and the same elements or components of the holder 42 will be described using the same names and reference numerals and repeated descriptions will be omitted here.

Referring to FIG. 15, the pogo pin 48 includes a connection end 485 to be connected to and sit on the connection pad 413 of the PCB 41, a contact point portion 481 to be connected to the cable assembly 30, and a spring 483 provided in a body 484 to provide elasticity to the contact point portion 481.

When the pogo pin 48 is mounted to the connection pad 413, at least a portion of the contact point portion 481 protrudes out of the housing 420 of the holder 42. The contact point portion 481 of the pogo pin 48 is inserted into the body 484 by a preset length and moves forward and backward in the body 484 and is elastically supported by the spring 483 when being connected to the cable assembly 30. The pogo pin 48 may be provided in lieu of the spring terminal 17 and the structure of the holder 42 may be substantially identical compared to the example described above. When the spring terminal 47 is inserted in the holder 42, the holder 42 may be disposed to allow the spring terminal 47 to be disposed on the connection pad 413.

After the fixing member 43 is fixed to the holder 42, the soldered portion 432 of the fixing member 43 is soldered to the PCB 41 to complete the assembling. However, the present disclosure is not limited to the example described herein and thus various methods, including soldering, may be used to connect the holder 42 to the PCB 41.

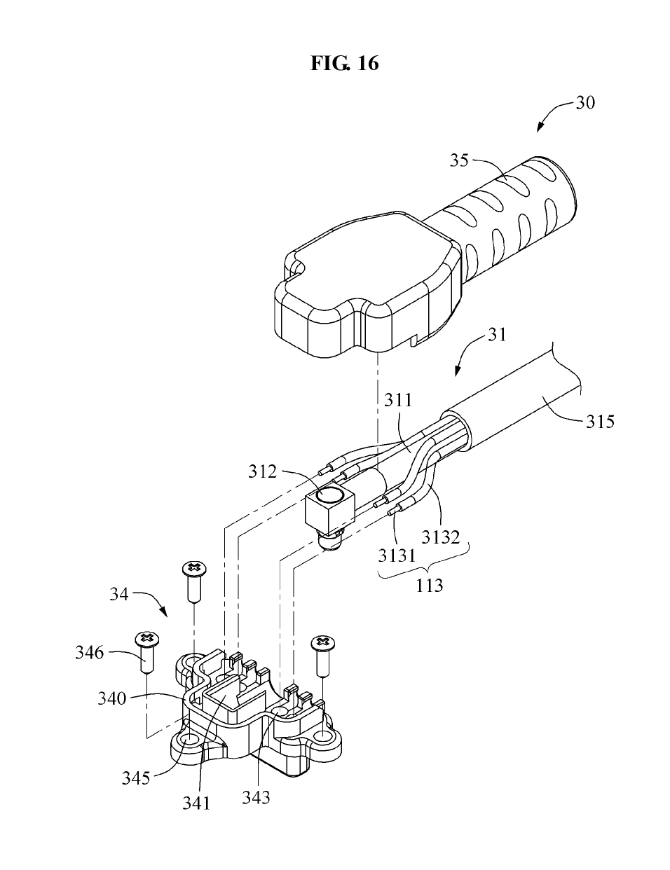

Further, as illustrated in FIG. 16, when the spring terminal 47 is provided in the PCB 41, manufacturing the cable assembly 30 to be in a form bent at 90° against the PCB 41 may be possible. FIG. 16 is an exploded perspective view of the cable assembly 30 of FIG. 14.

The cable assembly 30 to be described hereinafter is substantially the same as the example described above, except for a shape of a connector housing 34. Thus, the same elements or components of the cable assembly 30 will be described using the same names and reference numerals and repeated descriptions will be omitted.

Referring to FIG. 16, the cable assembly 30 includes the cable portion 31 including the coaxial cable 311, the signal cables 313, the sheath 315, the connector housing 34 provided at an end of the cable portion 31 to connect the cable portion 31 to the PCB 41, and the overmolded portion 35 to connect the cable portion 31 and the connector housing 34.

The connector housing 34 is formed to allow the cable portion 31 to be connected to the PCB 41 by being bent at 90° against the PCB 41 and a first cable joint 341 and a second cable joint 343 are bent at 90° relative to a direction of the cable portion 31. In addition, the connector housing 34 includes a body 340 and a joint 345 to which a fastener 346 is to be fastened.

Here, the coaxial cable 311 and the signal cables 313 of the cable assembly 30 are provided along an extended direction in the connector housing 34 and the first MMCX connector 312 having an angle of 90° is used. However, the present disclosure is not limited to the illustrative example described herein and thus various modifications may be made to a shape of the connector housing 34.

According to example embodiments, one or more effects to be described hereinafter may be achieved.

According to example embodiments, inclusion of a coaxial cable and a plurality of signal cables may prevent generation of heat and noise and thus enable obtainment of a higher-quality image.

In addition, the coaxial cable and the signal cables may be modularized in an integral form to facilitate mounting of a cable assembly onto a camera module and also facilitate assembling.

In addition, a spring terminal provided at one side of the cable assembly or one side of the camera module may enable stable maintenance of a contact between the signal cables and a PCB.

Further, a contact point portion and a spring of the spring terminal may be provided in an integral form to facilitate manufacturing and assembling.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only and not for purposes of limitation. Descriptions of features or aspects in each example are to be considered as being applicable to similar features or aspects in other examples. Suitable results may be achieved if the described techniques are performed in a different order and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A camera device for a vehicle comprising:
a camera module having a printed circuit board;
a cable assembly adapted to connect the camera module to the vehicle and having a coaxial cable and a plurality of signal cables; and
a plurality of spring terminals, formed of a conductive material, at least at one of one side of the camera module and at one side of the cable assembly elastically connecting the signal cables and the printed circuit board.

2. The camera device of claim 1, wherein:
(a) the spring terminals have a contact point portion at one end thereof and a connection end at another end thereof,
(b) the contact point portion is in contact with one side of the signal cables, or one side of the printed circuit board, and
(c) the connection end of the spring terminals is connected to another side of the signal cables or another side of the printed circuit board.

3. The camera device of claim 2, wherein the contact point portion is elastic.

4. The camera device of claim 2, wherein the spring terminals further have an elastic spring.

5. The camera device of claim 2, wherein the connection end of the spring terminals is a clip or a flange deformed and compressed against a circumference of the signal cables.

6. The camera device of claim 2, wherein the spring terminals are in the printed circuit board and the connection end of the spring terminals is connected to the printed circuit board.

7. The camera device of claim 1, wherein the spring terminals are pogo pins.

8. A cable assembly to be connected to a camera module of a camera device for a vehicle, the cable assembly comprising:
a cable portion comprising a plurality of signal cables and a coaxial cable aligned in a same direction as the signal cables; and
a connector housing at an end of the cable portion adapted to connect the cable portion to an external source.

9. The cable assembly of claim 8;
(a) further comprising a micro-miniature coaxial connector at an end of the coaxial cable, and
(b) wherein the connector housing comprises a first cable joint to which the micro-miniature coaxial connector is connected and a second cable joint to which ends of the signal cables are connected.

10. The cable assembly of claim 9, wherein the first cable joint and the second cable joint of the connector housing extend in the direction in which the signal cables and the coaxial cable are aligned.

11. The cable assembly of claim 9
(a) further comprising a plurality of spring terminals, each spring terminal corresponding to a signal cable, adapted to elastically connect the spring cables to a printed circuit board of the camera module and
(b) wherein the spring terminals are mounted to the second cable joint.

12. The cable assembly of claim 11, wherein:
(a) each spring terminal comprises a contact point portion at one end thereof and a connection end at another end thereof, and
(b) at least a portion of the contact point portion of the spring terminal elastically protrudes from the connector housing and the connection end is connected to a circumference of the signal cables.

13. The cable assembly of claim 11, wherein the spring terminal further comprises a spring providing elasticity.

14. The cable assembly of claim 11, wherein the spring terminal is a pogo pin.

15. The cable assembly of claim 8, further comprising an overmolded portion covering at least a portion of the cable portion and connecting the cable portion and the connector housing.

16. A camera module of a camera device for a vehicle comprising a cable assembly that comprises a coaxial cable and a plurality of signal cables, the camera module comprising:
a printed circuit board;
a micro-miniature coaxial connector in the printed circuit board adapted for connection to another micro-miniature coaxial connector of the coaxial cable;
a plurality of spring terminals, formed of a conductive material, elastically connecting the signal cables and the printed circuit board; and
a holder for the spring terminals.

17. The camera module of claim 16, wherein:
(a) the printed circuit board has a connection pad, and
(b) the spring terminals have:
(1) a contact point portion at one end thereof protruding from the holder and contacting the cable assembly, and
(2) a connection end at another end connected to the connection pad of the printed circuited board.

18. The camera module of claim 16, wherein the spring terminals further comprise a spring providing elasticity.

19. The camera module of claim 16, wherein the spring terminals are pogo pins.

20. The camera module of claim 16, wherein the holder includes a fixing member:
(a) connecting the holder to the printed circuit board, and
(b) soldered to the printed circuit board.
